(19) United States
(12) Patent Application Publication
(10) Pub. No.: US 2020/0261757 A1
(43) Pub. Date: Aug. 20, 2020

(54) Fire Suppression Coupling Access Hatch

(71) Applicants: Terry Gene Creekmore, Bryant, WI (US); James Schulz, Athens, WI (US)

(72) Inventors: Terry Gene Creekmore, Bryant, WI (US); James Schulz, Athens, WI (US)

(21) Appl. No.: 16/795,107

(22) Filed: Feb. 19, 2020

Related U.S. Application Data
(60) Provisional application No. 62/807,910, filed on Feb. 20, 2019.

(51) Int. Cl. A62C 35/68; E04D 13/035

(52) U.S. Cl. CPC A62C 35/68; E04D 13/0354

(57) ABSTRACT

An access hatch located on the exterior of a building, the interior of the access hatch including a coupling so as to provide connection of an exteriorly based water hose, tube, or pipe to link with an interiorly located water distribution system. The access hatch may be located on an exterior wall or the exterior of a building's roof. The access hatch has vertical sidewalls defining an area and which may additionally contain an exterior cover to prevent this defined area from being exposed to the elements. The cover may be on a hinged cover, or may be completely removable.

### CROSS REFERENCE TO RELATED APPLICATION

This application claims the benefit of U.S. Provisional Application 62/807,910, filed Feb. 20, 2019.

### FIELD

The present invention is directed to the field of fire suppression, and more particularly to the field of a coupling that allows an exteriorly located water hose to connect with a water sprinkler system located inside of a building.

### INTRODUCTION

Water sprinkler systems are a commonly used means to protect buildings from the damages that may occur due to a fire. Whether the building is commercial, industrial, or even residential, water sprinkler systems can be quite useful to prevent a fire from spreading throughout a building. It has been recognized in the fire prevention industry that a lot of buildings do not have the proper water capacity or pressure for a water sprinkler system to adequately quell a large fire. In these circumstances, just as in buildings without water sprinkler systems, it is imperative that a firefighter is brought on scene with additional water capacity so as to extinguish the fire properly and quickly. This additional water capacity is typically provided by a fire hydrant, water basins in a fire truck, or a similar water reservoir.

When firefighters arrive on scene, they may attach one end of their water hose to a water source such as those described above, and use the other end of the water hose to spray water onto a fire, or they may alternatively attach this water hose end to a fire suppression system. However, in order to get to an area to spray this water on the fire, a firefighter might have to physically enter a burning building, which in and of itself poses many grave dangers.

Besides the obvious risk of burning from the fire itself, firefighters have to combat the existence of steam in their endeavors. One known firefighting method is to spray water on the interior ceiling of a building or on the walls of a building to create a suffocating steam to eliminate the fire in a rapid manner. While creating this steam is effective, it may be difficult, depending on the particularities of the building and the fire, for a firefighter to enter a building and get near enough to the ceiling or walls in order to spray water and create this steam effect. Additionally, the moist heat created from this steam can cause burns on a firefighter's skin, even while the firefighter is wearing their personal protective equipment.

Firefighters may be able to reach a position to spray water on a fire from a higher vertical position so as to create the above-mentioned steam effect if the structural integrity of the building is not yet compromised. However, some roofs, such as metal roofs, can be quite dangerous for a firefighter to stand on for an extended period of time due to the absorption of heat and/or the reduction in friction on many metal roofs. When a building that has a metal roof is on fire, firefighters might be loath to climb onto the roof for the just mentioned reasons, which increases the likelihood of the building becoming a complete structural loss due to the fire.

What is needed, therefore, is a device which can reduce the burden on a firefighter by providing quick access to the water sprinkler system of a building, so as to increase the likelihood of quickly exterminating an interior building fire, while simultaneously reducing the inherent dangers for a firefighter when they enter a building.

### BRIEF SUMMARY

The present invention is directed to an access hatch and coupling for the purpose of adaptability with a fire suppression system. The present invention minimizes the dangers of entering a burning building by providing a quick access coupling for a hose. The invention is adaptable to be located on the exterior surface of a building roof or a building wall, such that a person may open the hatch cover on the access hatch so as to expose the coupling, and removably attach a hose to the coupling itself. Preferably, the interior of the coupling is attached to a water supply line with multiple sprinklers, so as to provide additional water pressure throughout the building without the requirement of ingressing the building itself.

The sprinkler system might in one circumstance be set such that the sprinklers are positioned to create a suffocating steam effect to eliminate the oxygen a conventional fire requires for sustenance. As the firefighters are not located within the building according to the aspects of this method, the steam burns associated with such a measure are severely minimized, while also increasing the likelihood of saving the building's structure itself. Another advantage is that the sprinkler system is provided with an extra source of high-pressure water through the access hatch coupling and exteriorly located water source.

According to one embodiment of the present invention, a hose coupling is provided which protrudes out of a building's roof or from a vertical exterior wall. The hose coupling is a connection device which is coupled to a fire suppression distribution system, such as a fire sprinkler assembly on the interior end of the hose coupling which is defined herein as the end of the hose coupling located within the building.

The distribution system may consist of a series of variable length pipes or generally tubular sections which can convey substances such as liquids, gases, slurries, powders, or small solids to a different area. It is presently thought that the distribution system may provide a quick distribution of water, other fire suppressing fluid, or foam to a needed area. For the sake of brevity, as used herein the term water shall include these aforementioned materials as well, as the situation may dictate. Preferably, the distribution system consists of a plurality of pipes, the branches from the main stack known herein as branch extensions. These branch extensions may be positioned in advantageous and strategic positions so as to distribute the water as quickly and conveniently as possible. It is thought that it may be preferable to locate at least one branch extension as close to beneath the center of the roof as possible, though the particularities of the building, the roof pitch, the roof rafters, the roof centers, and expected snow load or other load distribution on the roof will dictate and control the most advantageous quantity and position of each branch extension.

The exterior end of the hose coupling, defined as the end of the hose coupling located within the hatchway, is known herein as the water supply connection. The water supply connection is presently thought to be a threaded pipe portion which is preferably sized to the local municipalities' fire hose size. Presently it is thought that most municipalities use 1.5″-1.75″ NST threads, but the size of the water supply connection point and the threaded pipe thereof should be sized to what the responding firefighters' hoses shall be, and thus is adaptable for this purpose. The water supply connection may further be adaptable to alternate between a female threading and a male threading depending on the requirements thereof as determined by local municipalities.

To further be convertible depending on the particular circumstances, the water supply connection and the hose coupling thereof may be welded or otherwise attached to a secondary plate assembly known herein as the jimmy plate. The jimmy plate is a changeable plate assembly which rests upon the hatch base plate and is bolted or otherwise fastened to the hatch base plate. In one embodiment, the jimmy plate is generally centralized within the hatchway, and is bolted to welded nuts contained within the interior of the hatch base plate, known herein as the area within the roof or vertical exterior wall of a building. Should the jimmy plate be attached to welded nuts in such a fashion, the jimmy plate is able to be removed and replaced entirely from the exterior of the building. The replacement ability, though optional, allows quick replacement of a damaged hose coupling or water supply connection, or the customization of varying size threaded pipe should a municipality's fire department change their standard fire hose size.

The hose coupling may additionally be further fitted with a rubber or neoprene boot on the exterior end, also known as the water supply connection, that would receive a typical fire hose nozzle and could be held in place with frictional force imparted on by a human user, which could dispense the water into the coupling and distribution system.

Preferably, the water supply connection is surrounded by a hatch tower which is a frame for support and is designed to be mounted on a building's roof or exterior wall. The hatch tower is contemplated and defined herein to be a generally quadrilaterally shaped frame box, such as a square box, rectangular box, or the like. However it is to be understood that other not just-mentioned shapes may additionally be advantageous for a particular building and are specifically contemplated and protected herein, such as a hexagonal box, circular box, triangular box, or the like, and specifically designating and enumerating each specific shape shall be understood as captured by the present disclosure and the lack of naming each specific shape shall not be thought of as limiting in any fashion.

The hatch tower, whatever shape desired, contains a plurality of vertical sidewalls which create the hatchway upon which the exterior end of the coupling is stored. While a generally circular or cylindrical shape hatch tower shall literally contain a single continuous sidewall, it shall be referred to herein as if it were composed of a vertical sidewall for each general quadrant, such that a cylindrical hatch tower has four sidewalls for the purpose of the disclosure and the claims as designated herein.

In one embodiment of the present invention the vertical sidewalls have a consistent height and create a generally box shape. However, it is known and understood that for a particular roof pitch or other variable circumstances it may be best to have varying heights on a particular hatch tower, such that a side view of the hatch tower may look generally triangular, or trapezoidal. Thus in this way, when the vertical sidewalls are tapered relative to each other, the angle when the hatch cover is in an open position relative to the hatchway allows the water supply connection height to be greater in height than a portion of the lower portion of the hatch tower, which would allow better access for a firefighter, depending on the particularities of the building's roof or exterior wall, as the case may be.

The area between the vertical sidewalls creates a hatchway, which is defined herein as the volume created between the vertical sidewalls. The hatchway is the area where the exterior portion of the hose coupling resides. It is presently thought that the hatchway should be wide enough such that a firefighter may access the hose coupling and attach a fire hose while wearing gloves. It is thought this volume may be twelve inches or more wide, though the volume may be less or more depending on the particular circumstances of the area to be utilized.

The vertical sidewalls are presently thought to be connected to a base plate, such as a metal base plate having an upper and lower portion. The lower portion contacts with the exterior portion of a building's roof or exterior wall. The base plate is thought to be wide enough to span a building's roof trusses and be connected thereon. The upper portion of the base plate is the section upon which the vertical sidewalls are connected.

The upper portion of the vertical sidewalls may contain a generic lip seal or ridge in order to seat a gasket or a rubber seal. This additional protection may help prevent undesired water leakage into the hatchway. While optional, the lip seal and/or seal may be desired depending on the climate in which the building is located, as fluid entry of the hatchway while in cooler climates may create an ice buildup; such a buildup can cause great troubles for persons attempting to quickly attach a hose to the hose coupling.

On the exterior of a vertical sidewall, or alternatively on the hatch base plate, there may be loops or hooks to help hold a ladder steady according to one embodiment of the present invention. While an accessory feature, these loops, hooks, or other holding devices such as clamps or ridges among other examples known in the art, may be added to the present invention to keep a ladder steady while a firefighter is standing on the ladder and working, should the need arise.

To create the needed enclosure to protect from the elements, a hatch cover may be provided according to some aspects of the present invention. The hatch cover is thought of presently as a removably attached cover which surrounds and encloses the hatchway and is sized and adapted such as to prevent the hatchway from being exposed to the atmosphere and elements thereof. The attachment method may be a simple friction seal, a clasp, or a hinge, though any variety of removable attachment which is known to those with skill in the art may be effectual without departing from the spirit of the present invention.

Within the interior of the building and hatch base plate, at the distal end of the hose coupling, the hose coupling may be mated with a pipe, known as the main stack, which receives the initial water from the hose coupling and brings it towards the branch extensions. The main stack may be the same size as the hose coupling pipe and may be connected by any method deemed advantageous, such as a nipple fitting, a sleeve, or possibly a form of a wye union which would create multiple main stack(s). Should the main stack, and branch extensions thereof be of a different size than the hose coupling, which is contemplated as probable, the hose coupling end may be mated with a reducer fitting such as a bell coupling to provide the fluid or foam disbursement from the hose coupling to the smaller in diameter main stack.

The main stack will deliver the fluid or foam down to a desired height within the interior of a building, and connect with a branch multiplier, such as a tee valve or a cross valve. This branch multiplier will be the point of creation for the previously mentioned branch extensions. These branch extensions will be the offshoots of the water distribution system. The distribution system and branch extensions thereof will be customized based on the particularities of a specific building and the roof thereof. The distribution system may be wholly contained within the attic of an older residential building or may be delivered to water sprinklers located in individual rooms for maximum coverage.

Additionally, depending on the particularities, the branch extensions may further be fitted with adjustable pitch elbows, which provide rotational ability for the branch extensions. The rotational function may be desired to move through a roof strut, chord, or the truss thereof. Thus, the construction and components required for the water distribution system will vary building by building.

Just as the particulars of the water distribution system shall vary, so to the placement of the fire suppression coupling access hatch shall vary. While it may be preferable to place the access hatch as near to the ridge, or center of the pitch, of the roof as possible, it may not be feasible for some buildings. Thus, the access hatch is able to be mounted in multiple locations on a building's roof, and may even be located on a building's exterior vertical wall, which may be most preferable for larger buildings, such as large commercial buildings or multi-family residential properties.

These and various other features, advantages, modes, and objects of the present invention will be made apparent from the following detailed description and any appended drawings.

### DRAWINGS DESCRIPTION

One or more preferred exemplary embodiments of the present disclosure are illustrated in the accompanying drawings in which like reference numerals represent like parts throughout and in which:

FIG. 1 is a perspective view of a preferred embodiment of the fire suppression coupling access hatch with the hatch cover deployed in an open position relative to the hatchway;

FIG. 2 is a perspective view of the interior side of a building highlighting a preferred embodiment of the fire suppression coupling access hatch as attached with fire suppression distribution system;

FIG. 3 is a perspective view of a preferred embodiment of the fire suppression coupling access hatch, highlighting the maneuverability of the distribution system;

FIG. 4 is a top-down perspective view of a preferred embodiment of the fire suppression coupling access hatch wherein a hatch cover is shown in a closed position, sealing the hatchway from view; and

FIG. 5 is a depiction of a preferred embodiment of the fire suppression coupling access hatch wherein the access hatch is attached to a fire suppression distribution system complete with sprinklers in a hypothetical building environment.

FIG. 6 is a cutaway view of a generic building, highlighting the use of the fire suppression access hatch with a fire suppression system.

Before explaining one or more embodiments of the disclosed invention in detail, it is to be understood that this invention is not limited in its application to the details or modes of construction and the arrangement of the components set forth in the following description or previously disclosed illustrations. This invention is capable of multiple embodiments and modes, which can be practiced or carried out in many various ways. Also, it is to be understood that the phraseology and terminology employed herein is for the purpose of description, and should not be regarded as limiting, or used as an absolute.

### DETAILED DESCRIPTION OF THE PREFERRED EMBODIMENT

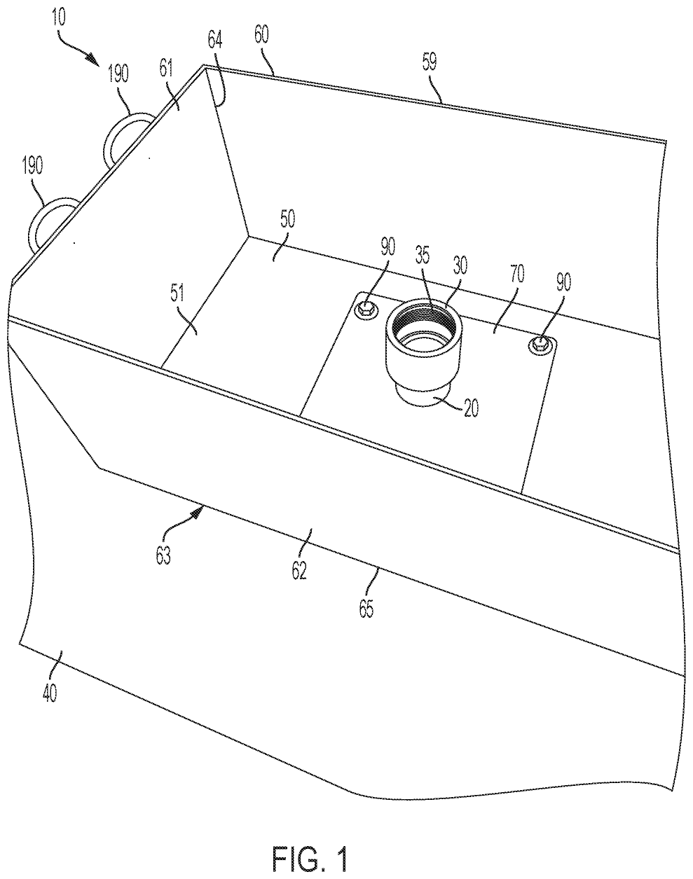

Referring now to the drawings in detail, FIG. 1 illustrates a preferred embodiment of a fire suppression coupling access hatch 10 constructed in accordance with the present invention. The access hatch 10 is shown with the hose coupling 20 and water supply connection 30 therefrom protruding from the hatch base plate upper portion 40 and jimmy plate 70 into the volume known herein as the hatchway 50. The vertical sidewalls 60 are shown here as attached to the hatch base upper portion 40 at locations known as the connection points 65. These vertical sidewalls 60 form the volume formed within the vertical sidewall interior(s) 61 known as the hatchway 50 and the shape of said hatchway 50 will be directly dependent upon the shape of the frame, otherwise known as the hatch tower 63, as described later.

The water supply connection 30 is located at the exterior distal end of the hose coupling 20 located in the hatchway and may contain a rubber boot to allow for a friction seal, or may alternatively contain connection threads 35, as shown here. These connection threads 35 allow for the mating of a pipe or hose, and such connection threads 35 may be of the male threading, female threading, or any other type of threading that is required to allow for a solid mating between the coupling 20 and the external water supply. As is made clear to those with skill in the art, the water supply connection 30 thus may be adaptable with either a mating component or may itself be replacement to allow for different threading type or size as required.

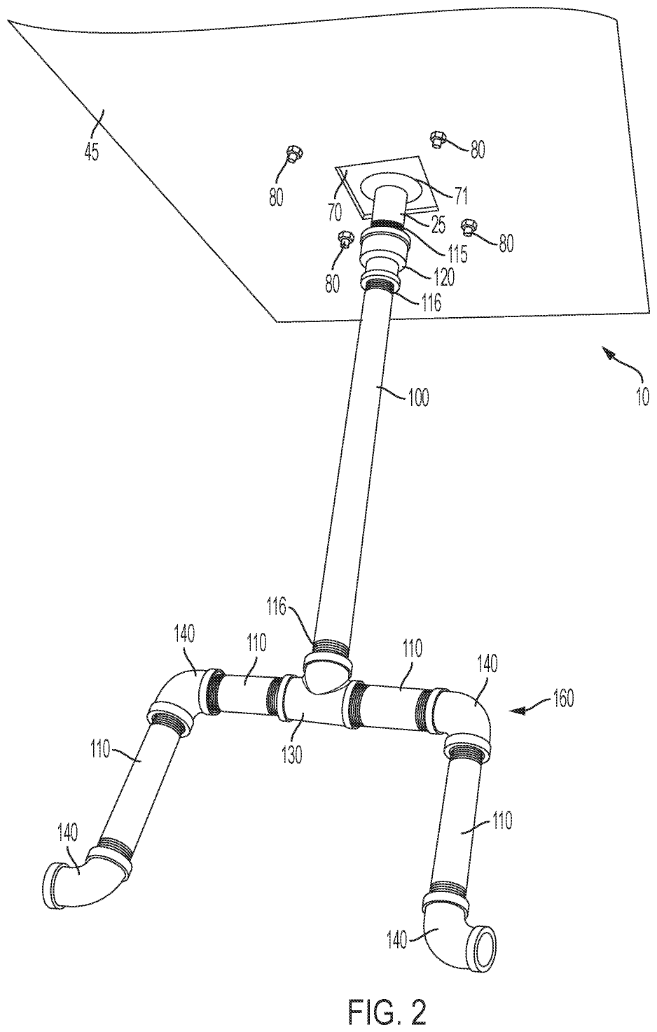

In this particular embodiment, the hose coupling 20 and water supply connection 30 also protrude into the hatchway 50 through the hatchway base upper interior 51, which is known for description as the part of the hatch base plate upper portion which is within the frame/hatch tower 63, as well as through the jimmy plate 70 attachment, which provides optional quick replacement/adjustment capabilities as mentioned above. The jimmy plate 70 rests on the hatch base plate upper portion 40 and encompasses the entirety of the aperture 71 that exists in the hatch base plate (as shown in FIG. 2) while also surrounding the hose coupling 20. The vertical sidewall exterior(s) 62 combine to form what is known collectively as the hatch tower 63, or frame, and is thought of as the protective shell that surrounds the water supply connection 30 and forms the size and shape of the hatchway 50. The vertical sidewalls 60 are connected by an attachment method such as screws, bolts, or welding to name a few, and said vertical sidewalls 60 thus meet forming a vertical sidewall connection seam 64. As described above, on a distal end of the vertical sidewalls 60 away from the distal end which connects to the hatch base plate upper portion 40 may further contain a lip seal 59, which can act as a seat for a rubber seal or gasket, to provide additional protection from the elements.

The optional jimmy plate 70, if provided, is attached to the hatch base plate upper portion 40 using attachment fasteners 90, which shown here are bolts, but may be any other similar attachment method without departing from the spirit of the invention. The attachment fasteners 90 contact with the hatch base plate interior 45 as well (as shown in FIG. 2) and may additionally be connected with weld nuts 80. While optional, the use of weld nuts 80 allows the jimmy plate 70 to be disengaged solely from operation within the hatchway 50, and allows for the exposure of the hatch base aperture 71, which is shown in FIG. 2, and is known as the opening that is covered by the jimmy plate 70 itself. This allows for the replacement of a hose coupling 20, if deemed necessary.

Additionally, a ladder attachment device 190 such as a hook, a loop, or a clamp is shown in this Figure. This ladder attachment device 190 may be provided for ease of use, and to promote safety while working. This optional attachment allows a firefighter to hook their ladder in place, providing stability if working in a vertically extended position. These ladder attachment devices 190 are generally thought to connect to the vertical sidewall exterior 62 as shown here, but may alternatively be located on the hatch base plate upper portion 40, if the orientation of the access hatch 10 deems that an ideal location.

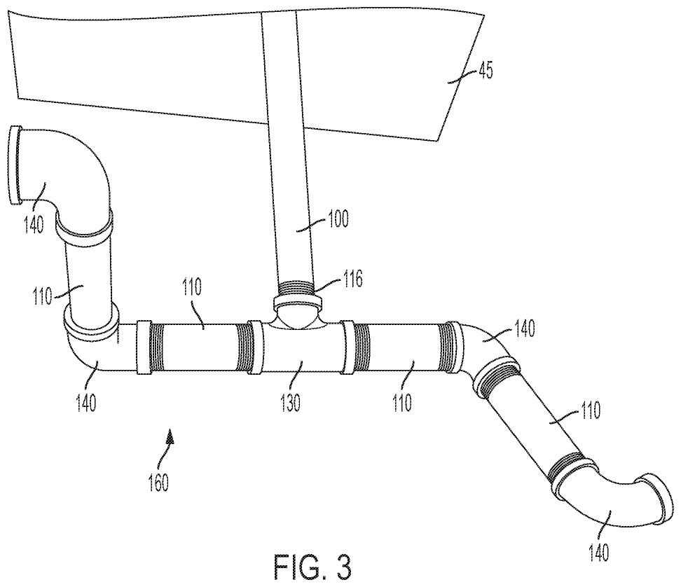

Turning now to FIGS. 2-3, a preferred embodiment of the present invention is shown from the interior side of the fire suppression coupling access hatch 10 and further showcasing the adaptability with a general fire suppression distribution system 160. In this view the hatch base plate lower portion 45 is shown, which is the part which contacts with a building's exterior wall or roof. The hatch base plate lower portion 45 is preferably sized such that it may be attached to trusses in the roof or to the supporting studs in an exterior wall should the access hatch 10 be deployed there. Attachment methods will vary depending on the location placed and the particularities of the building and the surrounding environment of said building, but any securing means may work, such as bolts or screws, though other known in the art fasteners may work best based on conditions. Also depicted are the optional weld nuts 80 that secure the jimmy plate 70 and the attachment fasteners 80 therefore, as described above. As shown here in FIG. 2, the aperture 71 is shown, which is the opening where the exterior end of the hose coupling 20 enters into the hatchway 50 as depicted in FIG. 1. Here, the hose coupling interior end 25, the distal end of the coupling located within the interior of a building, is shown with an optional reducer 120 attachment which couples to the main stack 100 of the distribution system 160. The reducer 120 is the connection device which allows the wider in diameter hose coupling interior 25 pipe to connect with the smaller diameter main stack 100. The hose coupling interior 25 mates with the main stack 100 at a coupling mating location 115, and thus connects the distribution system 160 itself to the exterior supply source of fire suppression material.

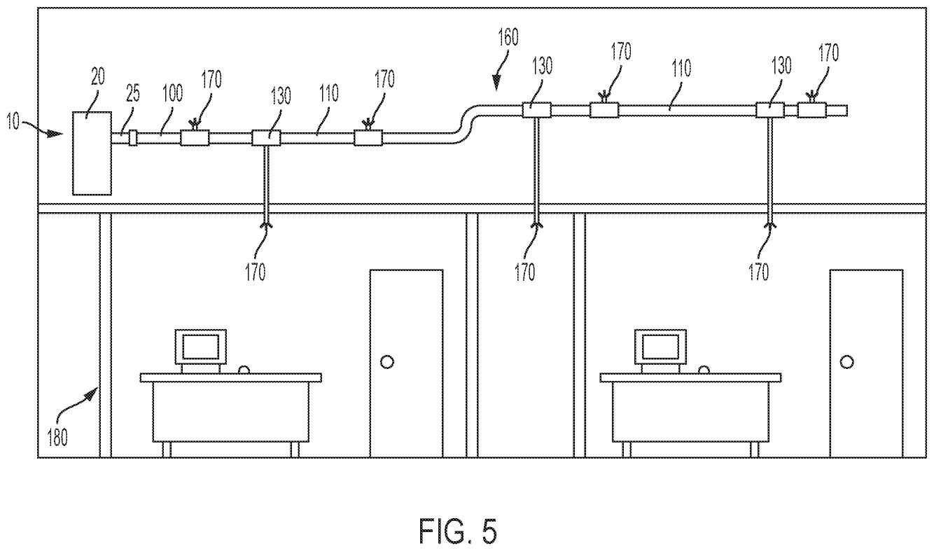

The main stack 100 feeds the created supply line down to a branch multiplier 130, which connects at a main stack mating location 116, which is where the main stack 100 connects with another piece of the system. The branch multiplier 130 here is shown in this depiction as a pipe tee, though it is known and appreciated that it may be a cross pipe, or any other multiplying type, depending on the particularities of the distribution system 160 and the building therefore. The branch extensions 110 are shown here as short in length pipes for ease of viewing but may also be larger or smaller depending on the distribution system 160 requirements. The branch extensions 110 deliver the payload of fire suppression fluid, foam, altogether water as described above, to the required destination but may further be redirected with adjustable arm extensions 140 as shown here, and as required to get through joists, studs, trusses, and other requirements of the particular building construction. Preferably the adjustable arm extensions 140 provide rotational ability such that the payload may be diverted around obstacles as the situation may dictate, as shown in FIG. 3. Should an adjustable arm extension 140 be required, more branch extensions 110 may be connected thereto and delivered to either further adjustable arm extensions 140 as shown here, or may be delivered to a payload distribution device 170 such as a sprinkler, a spinner, nozzle, or a hose such as shown in FIG. 5.

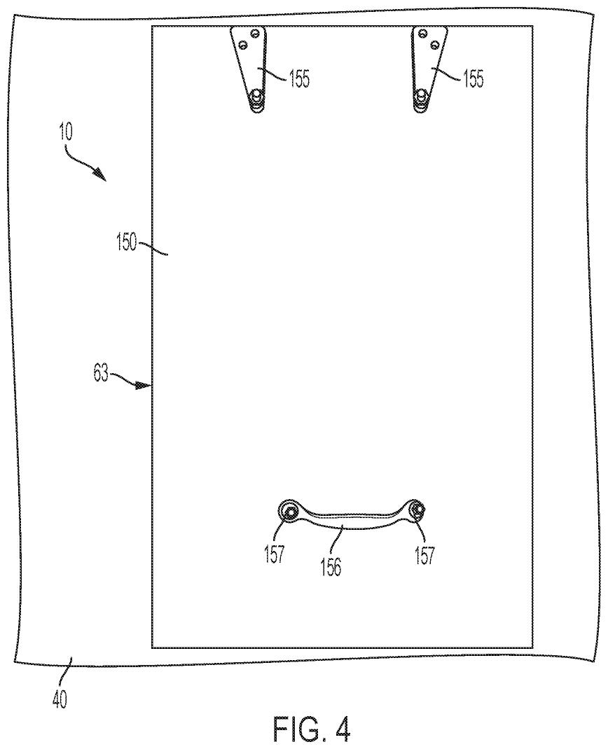

Now turning to FIG. 4, the fire suppression access hatch 10 is shown with a hatch cover 150 in a closed position, relative to the hatchway 50. This is the position which will be the standard position for the access hatch 10 when not in use. The hatch cover 150 may rest upon the lip seal 59 of the vertical sidewalls 60, in the aggregate known as the hatch tower 63, and protects the hatchway 50 from the elements. In this embodiment, the hatch cover 150 is closed with removable attachment devices 155 which are shown here as hinges. The hinges are one known method of removably attaching a hatch cover 150, though a variety of other embodiments which are known in the art may be used, some of which are described above. To help with facilitating transitioning from a closed position relative to the hatchway 50 to an open position relative to the hatchway 50, a handle 156 may be provided, and shown in this figure. A variety of alternative handles or a plurality of handles may be provided without departing from the spirit of the invention. It is specifically contemplated that alternative methods of moving the access hatch 10 to an open position may be provided which might provide ease of use for a firefighter wearing thick gloves such as a stick handle, a plurality of handles, or a slidable hinge. The handle 156 as shown here is also attached to the hatch cover 150 by way of handle connection points 157 which here are small bolts, by may also be accomplished though screws, nails, or by welding.

Looking to FIG. 5 now, a preferred embodiment of the present invention is depicted in use through a cutaway version of a building 180, depicting the access hatch 10 on the exterior of said building 180. In this drawing, it is shown how the fire suppression coupling access hatch 10 works in conjunction with a distribution system 160 to deliver a payload to a desired area. In this depiction, as described above, the hose coupling 20 is attached to a main stack 100 at the hose coupling interior distal end 25, and mate with various branch multipliers 130 and branch extensions 110 which all in conjunction further move the payload to a desired area. At strategic points a payload distribution device 170 is positioned for use when needed. In this simple depiction of the basic principles of the present invention, the payload distribution devices 170 shown are sprinklers, with some being positioned in rooms of a generic building, and others positioned within the generic building's attic. As described above, the specific payload distribution device 170 may vary and are best selected based on the type of external fire suppression material which will be utilized.

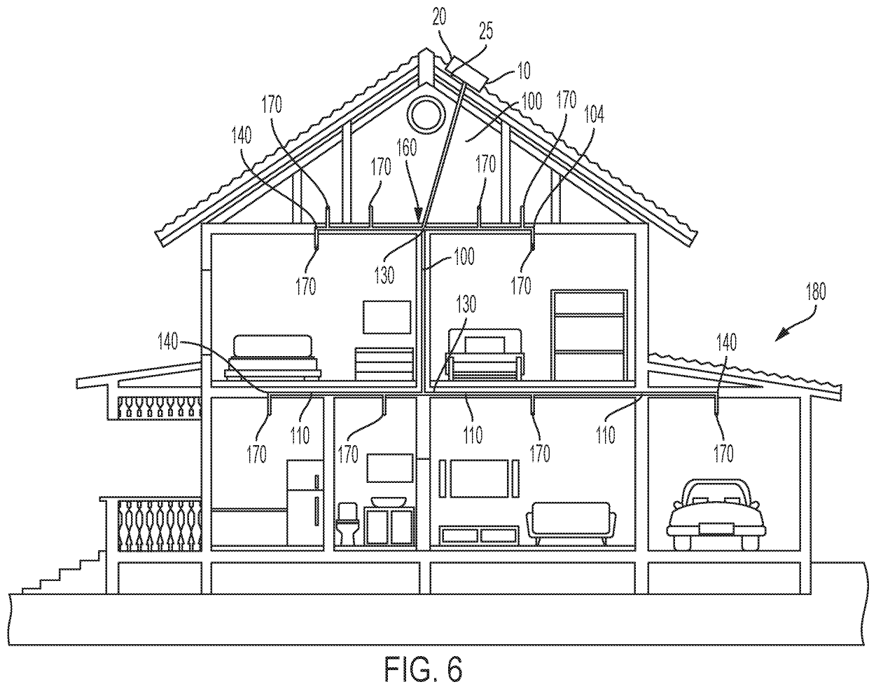

Finally, FIG. 6 is shown, wherein the fire suppression coupling access hatch 10 is depicted on a cutaway of a generic building, highlighting the entirety of the fire suppression distribution system 160 as desired. In this image, it is readily apparent to those with skill in the art how an external source of fire suppression material may be provided by mating with the coupling 20, entering through the hose coupling interior 25 and thus entering the main stack 100 and the entirety of the distribution system 160 itself. After reaching the branch multiplier 130, the fire suppression material travels down alternate paths, including other branch multipliers 130, branch extensions, or adjustable arm extensions 140 as required until reaching a payload distribution device 170.

Understandably, the present invention has been described above in terms of one or more preferred embodiments and methods. It is recognized that various alternatives and modifications may be made to these embodiments and methods that are within the scope of the present invention. It is also to be understood that, although the foregoing description and drawings describe and illustrate in detail one or more preferred embodiments of the present invention, to those skilled in the art, as well as widely differing embodiments, applications and methods without thereby departing from the spirit and scope of the invention.

What is claimed is:

1. An access hatch adapted for use on the exterior of a building, said access hatch comprising:
a frame having a multitude of vertically standing sidewalls defining an enclosed hatchway;
a base plate having an upper portion and a lower portion;
wherein the base plate upper portion is attached to a distal end of each vertically standing sidewall;
wherein the base plate lower portion is attached to the exterior surface of a building;
a hose coupling having an interior distal end contained within the building and an exterior distal end projected through the building and extending beyond the base plate into the hatchway of the access hatch; and
a hatch cover, removably connected to the frame and enclosing the hatchway, said hatch cover having an open first position relative to the hatchway, and a closed second position relative to the hatchway.

2. The access hatch of claim 1, wherein a fire suppression distribution system is provided and connected to the interior distal end of the hose coupling.

3. The access hatch of claim 2, wherein the fire suppression distribution system further comprises a payload distribution device for distribution of fluid to a designated area.

4. The access hatch of claim 3, wherein the exterior distal end of the hose coupling is adapted to receive a fire hose.

5. The access hatch of claim 3, wherein the exterior distal end of the hose coupling further comprises a hose coupling adapter, said hose coupling adapter having threading.

6. The access hatch of claim 3, wherein the hatch cover additionally comprises a handle.

7. The access hatch of claim 6, wherein the hatch cover is hingedly attached to the frame.

8. The access hatch of claim 6, wherein the fire suppression distribution system comprises a plurality of payload distribution devices.

9. An access hatch positioned on the exterior of a building, the access hatch comprising:
a plurality of vertically upright sidewalls defining a hatchway;
a base plate having an upper portion and a lower portion, the base plate further defining an aperture therein;
wherein the base plate upper portion is connected to the vertically upright sidewalls;
wherein the base plate lower portion is affixed to the exterior of a building;
a hose coupling having an interior distal end contained within the building and an exterior distal end projected through the building extending through the base plate aperture and into the hatchway;
a jimmy plate encompassing the aperture of the base plate lower portion and surrounding the entirety of the hose coupling, said jimmy plate attached to the base plate by mounting means; and
a hatch cover, removably connected to a vertically upright sidewall and enclosing the entirety of the hatchway, said hatch cover having an open first position relative to the hatchway, and a closed second position relative to the hatchway.

10. The access hatch of claim 9, wherein the hose coupling exterior distal end contains water supply connection threads.

11. The access hatch of claim 10, wherein the upper plate is welded to the vertically upright sidewalls.

12. The access hatch of claim 11, wherein the plurality of vertically upright sidewalls form a generally quadrilateral shape relative to each other.

13. The access hatch of claim 12, wherein the plurality of vertically upright sidewalls are welded to each other.

14. The access hatch of claim 11, wherein a fire suppression distribution system is attached to the interior distal end of the hose coupling.

15. The access hatch of claim 14, wherein the fire suppression distribution system additionally comprises a plurality of payload distribution devices.

16. The access hatch of claim 15, wherein the payload distribution devices are sprinklers.

17. An access hatch mounted on the exterior of a building, the access hatch adapted for use with a fire suppression distribution system, the access hatch comprising:
a generally quadrilateral shaped frame consisting of a plurality of vertical sidewalls having two distal ends;
a base plate having an upper base portion and a lower base portion, wherein the upper base portion is attached to a distal end of each vertical sidewall, and wherein the lower base portion is attached to the exterior portion of a building;
wherein the base portion further defines an opening therethrough;
a jimmy plate encompassing the entirety of the opening in the base plate, the jimmy plate being removably attached to the exterior of the base plate;
a hose coupling having an interiorly located distal end positioned within the building and an exteriorly located distal end projected through the building, base portion, the jimmy plate, and into the hatchway;
a hatch cover, hingedly connected to a vertical sidewall and enclosing the hatchway, said hatch cover having an open first position relative to the hatchway, and a closed second position relative to the hatchway;
a handle located on an exterior portion of the hatch cover, adapted to be received by a human hand; and
a fire suppression distribution system coupled to the interior distal end of the hose coupling, the fire suppression distribution system having a main stack, a plurality of branch extensions, and a plurality of payload distribution devices.

18. The access hatch of claim 17, wherein the jimmy plate is removably attached to the base plate with bolts.

19. The access hatch of claim 18, wherein the payload distribution devices are sprinklers.

20. The access hatch of claim 19, wherein the upper base portion is attached to the distal end of each vertical sidewall by means of welding.
